(19) United States
(12) Patent Application Publication
(10) Pub. No.: US 2026/0093194 A1
(43) Pub. Date: Apr. 2, 2026

(54) DEVELOPING DEVICE AND IMAGE FORMING APPARATUS

(71) Applicants: Tomoki TSUJI, Kanagawa (JP); Yutaka TAKAHASHI, Kanagawa (JP); Hiroshi KIKUCHI, Kanagawa (JP); Toshio KOIKE, Tokyo (JP); Hideki KIMURA, Kanagawa (JP)

(72) Inventors: Tomoki TSUJI, Kanagawa (JP); Yutaka TAKAHASHI, Kanagawa (JP); Hiroshi KIKUCHI, Kanagawa (JP); Toshio KOIKE, Tokyo (JP); Hideki KIMURA, Kanagawa (JP)

(73) Assignee: Ricoh Company, Ltd., Tokyo (JP)

(21) Appl. No.: 19/313,155

(22) Filed: Aug. 28, 2025

(30) Foreign Application Priority Data
Sep. 30, 2024 (JP) 2024-171457

(51) Int. Cl. G03G 15/08

(52) U.S. Cl. CPC G03G 15/0898; G03G 15/0808; G03G 15/0877; G03G 15/0891; G03G 2215/083; G03G 2215/0833

(57) ABSTRACT

A developing device is provided including: a developer carrier that carries a developer and develops a latent image on a latent image bearer; and a casing. The casing includes: a developer container; a gap former that forms an inflow gap; a first conveyance path including a first conveyer that conveys the developer collected from the developer carrier; and a second conveyance path including a second conveyer that conveys the developer in a direction opposite to a developer conveying direction of the first conveyer. The inflow gap includes a first region where the developer is spiked by a magnetic pole of the developer carrier, and a second region in which a gap between the gap former and the developer carrier is larger than that in the first region. The first conveyer includes a delivery facilitator that facilitates delivery of the developer to the second conveyance path.

### CROSS-REFERENCE TO RELATED APPLICATIONS

This patent application is based on and claims priority pursuant to 35 U.S.C. § 119 (a) to Japanese Patent Application No. 2024-171457, filed on Sep. 30, 2024, in the Japan Patent Office, the entire disclosure of which is hereby incorporated by reference herein.

### BACKGROUND

### Technical Field

The present disclosure relates to a developing device and an image forming apparatus.

### Related Art

Conventionally, there has been known a developing device including a developer carrier that carries a developer including a magnetic carrier and a toner on a surface and develops a latent image on a latent image bearer, and a casing that forms an internal space that accommodates the developer inside and is provided with an opening that causes a part of a surface of the developer carrier in a rotation direction of the developer carrier to face the latent image bearer. The casing includes a first conveyance path including a first conveyer that conveys the developer collected from the developer carrier in an axial direction of the developer carrier, and a second conveyance path disposed in parallel with the first conveyance path and including a second conveyer that receives the developer conveyed to a most downstream side of the first conveyance path in a conveyance direction, and conveys the received developer in a direction opposite to a developer conveying direction of the first conveyer.

### SUMMARY

Embodiments of the present invention provides a developing device that includes a developer carrier and a casing. The developer carrier carries a developer including a magnetic carrier and a toner on a surface thereof and develops a latent image on a latent image bearer. The casing includes: a developer container that accommodates the developer inside; a gap former that forms an inflow gap with the surface of the developer carrier therebetween, at a downstream side of a developing region where the developer carrier faces the latent image bearer in a rotation direction of the developer carrier, to allow outside air to flow into the casing through the inflow gap along with rotation of the developer carrier; a first conveyance path including a first conveyer that conveys the developer collected from the developer carrier in an axial direction of the developer carrier; and a second conveyance path disposed in parallel with the first conveyance path and including a second conveyer that receives the developer conveyed to a most downstream side in a conveyance direction of the first conveyance path, and conveys the received developer in a direction opposite to a developer conveying direction of the first conveyer. The inflow gap includes a first region located in a region where the developer carried on the developer carrier is spiked by a magnetic pole of the developer carrier, and a second region located on a downstream side of the first region in the rotation direction of the developer carrier and in which a gap between the gap former and the surface of the developer carrier is larger than that in the first region. The first conveyer includes, on a downstream side in the conveyance direction, a delivery facilitator that facilitates delivery of the developer to the second conveyance path.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic configuration view of an image forming apparatus according to an embodiment;

FIG. 2 is a schematic perspective view of the image forming apparatus illustrated in FIG. 1;

FIG. 3 is a perspective view of a process cartridge;

FIG. 4 is a schematic configuration view of the process cartridge illustrated in FIG. 3;

FIG. 5 is a schematic configuration view of a developing device;

FIG. 6 is a view describing a magnetic flux density of a magnet roller;

FIG. 7 is a view describing a casing gap;

FIGS. 8A and 8B are views describing a related art;

FIG. 9A is a schematic perspective view of a collection screw according to an embodiment at a downstream side in a developer conveying direction;

FIG. 9B is an enlarged view of a periphery of a portion where the developer is transferred from a collection conveyance path to a stirring conveyance path;

FIG. 10A is a schematic configuration view of a collection conveyance path according to an embodiment at a downstream side in a developer conveying direction;

FIG. 10B is a cross-sectional view taken along line A-A of FIG. 10A;

FIG. 11 is a schematic configuration view of a developing device provided with a suction duct;

FIG. 12 is a table summarizing configurations of Example 1 and Comparative Examples 1 and 2 and scattering results of a developer;

FIG. 13 is a graph illustrating a developer amount and a toner scattering speed in the developing device of Example 1 and Comparative Examples 1 and 2;

FIG. 14 is a table summarizing Verification Experiment 2 of Example 1, Comparative Example 3, and Comparative Example 4;

FIG. 15 is a table summarizing Verification Experiment 2 of Example 1 and Comparative Example 5;

FIG. 16 is a graph illustrating toner scattering speeds in Example 1 and Comparative Examples 3 and 4;

FIG. 17 is a graph illustrating toner scattering speeds in Example 1 and Comparative Example 5;

FIG. 18 is a view of a modification of a paddle configuration;

FIG. 19 is a diagram describing an arrangement of a second magnetic pole in Verification Experiment 3; and

FIG. 20 is a graph illustrating a toner scattering speed in the arrangement of the second magnetic pole.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to the present disclosure, scattering of developer can be favorably suppressed.

Hereinafter, an image forming apparatus according to an embodiment of the present disclosure will be described.

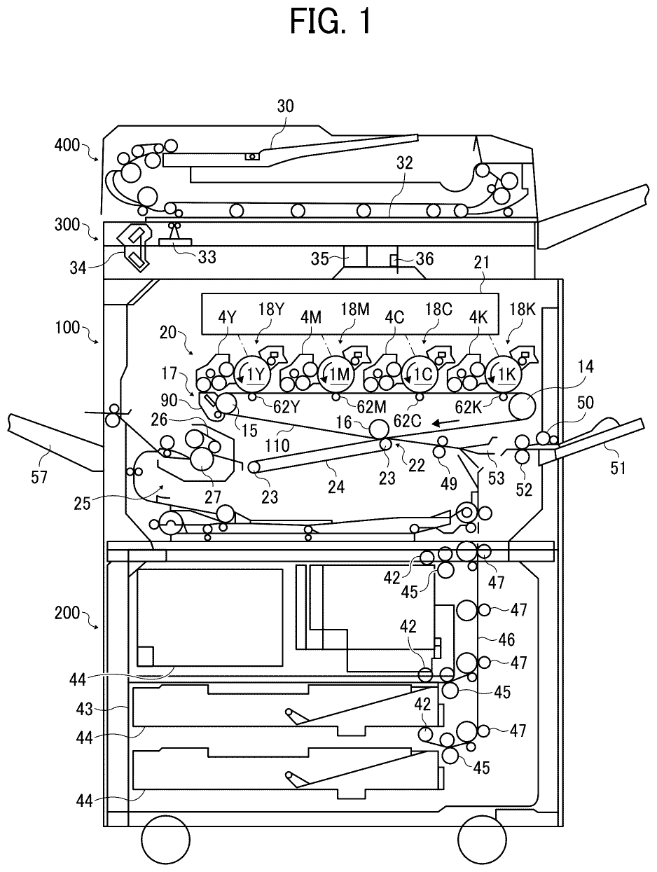

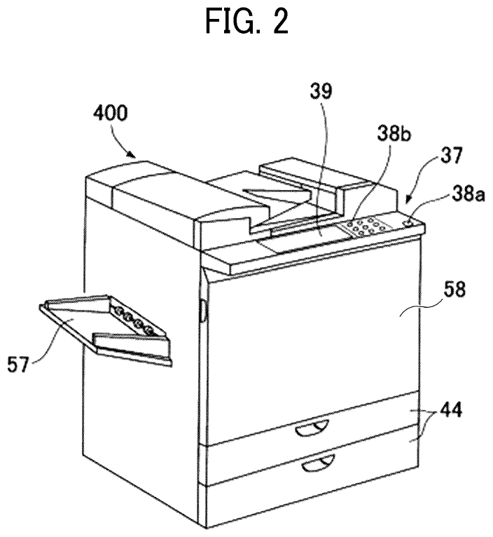

FIG. 1 is a schematic configuration view of an image forming apparatus according to an embodiment. FIG. 2 is a schematic perspective view of the image forming apparatus illustrated in FIG. 1.

The image forming apparatus is a tandem type color laser copying machine in which a plurality of photoconductors is arranged in parallel, and includes a printer unit 100, a sheet feeding device 200 for loading the same, a scanner 300 fixed on the printer unit 100, and the like. The image forming apparatus also includes an automatic document feeder 400 fixed on the scanner 300.

As illustrated in FIG. 2, on a front side of the image forming apparatus, an operation display unit 37 for giving an operation instruction to each of the above-described devices and equipment in the image forming apparatus and confirming an operation status is provided. In the operation display unit 37, various key buttons and the like including a copy start button 38a and a numeric keypad 38b, and a touch panel type liquid crystal display unit 39 are arranged.

On the front side of the image forming apparatus, a front door 58 that opens and closes when process cartridges 18Y, 18M, 18C, and 18K are attached and detached or when various inspections and maintenance are performed is provided.

The present image forming apparatus includes a controller including a central processing unit (CPU) or the like that controls the following devices in the image forming apparatus. The operator can select one of three modes for single-sided print mode, which is a mode for forming an image on one side of a transfer sheet, by sending a command to the controller by a key input operation on the operation display unit 37. The three single-sided print modes include a direct discharge mode, a reverse discharge mode, and a reverse decal discharge mode.

As illustrated in FIG. 1, the printer unit 100 includes an image forming unit 20 including four process cartridges 18Y, 18M, 18C, and 18K for forming images of respective colors of yellow (Y), magenta (M), cyan (C), and black (K). Y, M, C, and K attached after the numbers of the reference numerals indicate members for yellow, cyan, magenta, and black.

In addition to the process cartridges 18Y, 18M, 18C, and 18K, an optical writing unit 21, an intermediate transfer unit 17, a secondary transfer device 22, a registration roller pair 49, a belt fixing type fixing device 25, and the like are arranged. The optical writing unit 21 includes a light source, a polygon mirror, an f-θ lens, a reflection mirror, and the like, and irradiates a surface of a photoconductor described later with laser light based on image data.

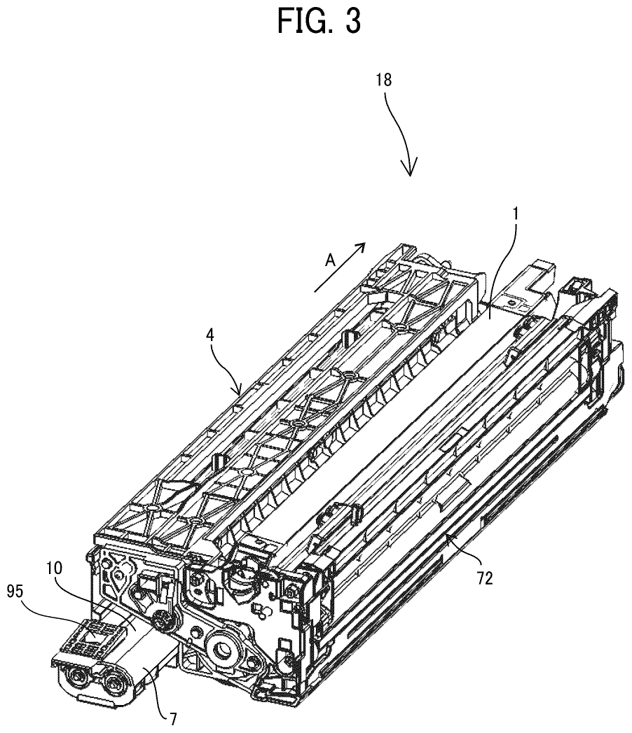

FIG. 3 is a perspective view of the process cartridge 18. Here, since the configuration of each process cartridge 18 is substantially the same, in the following description, the configuration and operation of the process cartridge 18 will be described while omitting the color coding suffixes (Y, C, M, and K). The process cartridge 18 is attached to the main body of the image forming apparatus by opening the front door 58 illustrated in FIG. 2 and inserting the process cartridge into an attachment space in the main body of the image forming apparatus from the front side toward the back side in the direction indicated by arrow A in FIG. 3. The process cartridge 18 includes a drum-shaped photoconductor 1, a drum cleaning unit 72 disposed around the photoconductor 1, a charging unit 71, and a developing device 4. The developing device 4 includes a developer container 40a, and a heat dissipation unit 120 is formed on a side surface of the developer container 40a.

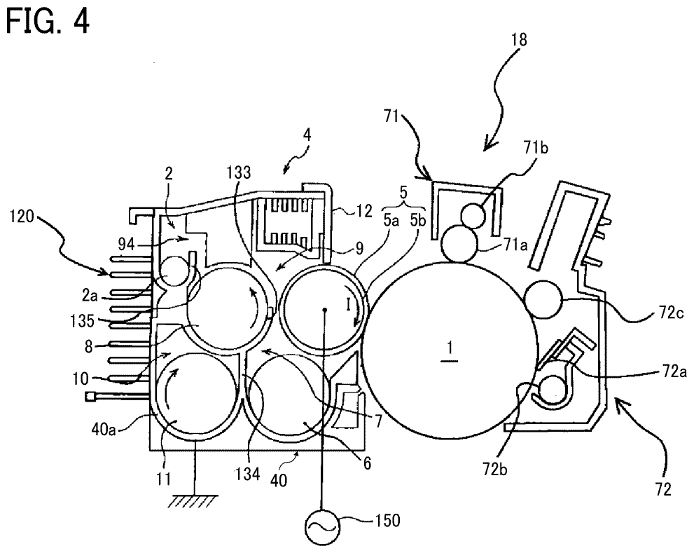

FIG. 4 is a schematic configuration view of the process cartridge 18.

As illustrated in FIG. 4, the drum cleaning unit 72 mainly includes a cleaning blade 72a, which is an elastic member elongated in the rotation axis direction of the photoconductor 1, and a discharge screw 72b. One side (abutting side) of the cleaning blade 72a extending in a longitudinal direction is pressed against the surface of the photoconductor 1 as an edge to separate and remove unnecessary contaminants such as residual transfer toner on a surface of the photoconductor 1. The removed toner is discharged to the outside of the drum cleaning unit 72 by the discharge screw 72b. In the drum cleaning unit 72, a neutralizer 72c to which a direct current (DC) voltage is applied is disposed. The charging unit 71 mainly includes a charging roller 71a disposed in contact with the photoconductor 1, and a charging roller cleaner 71b rotating in contact with the charging roller 71a.

The developing device 4 includes a developing roller 5 as a developer carrier that supplies toner to a latent image on the surface of the photoconductor 1 while moving on the surface in a direction of arrow I in FIG. 4 and performs development, and a development casing 40 that accommodates a two-component developer including toner and a carrier. In the present embodiment, a two-component development method using a two-component developer including toner and a carrier is adopted, but a one-component development method using a magnetic one-component developer may be adopted as long as the developer is supported on a developer carrier to be described later by magnetic force. The developing roller 5 includes a magnet roller 5b including a plurality of magnets fixed inside, and a cylindrical developing sleeve 5a including a non-magnetic material that encloses the magnet roller 5b and rotates around the magnet roller 5b. When the developing sleeve 5a rotates around the magnet roller 5b forming the plurality of magnetic poles, the developer moves on the developing roller 5 with the rotation.

When a developing bias is applied to the developing sleeve 5a of the developing roller 5 from a developing power supply 150 as a developing bias applying unit, a developing electric field is formed between the developing sleeve 5a and the photoconductor 1 in a developing region. Due to this developing electric field, the toner in the developer on the surface of the developing sleeve 5a is supplied to the latent image on the surface of the photoconductor 1 in the developing region, and the latent image on the photoconductor 1 is developed.

In the present embodiment, as the developing bias, an alternating current (AC) bias having a peak voltage of 1 kV or more is applied to the developing sleeve 5a. By using the AC bias as the developing bias, the toner away from the carrier can be increased as compared with a DC bias, developing performance can be improved, and a sharp image with high sharpness can be obtained.

In addition, a development doctor 12 as a developer regulating member that regulates the developer supplied to the developing roller 5 to a thickness suitable for development is provided on a downstream side in a surface moving direction from a portion facing a supply screw 8 of the developing roller 5. The developer container 40a has a first partition wall 133 and a second partition wall 134, and the first partition wall 133 and the second partition wall 134 partition the developer container 40a into a supply conveyance path 9, a collection conveyance path 7 as a first conveyance path, and a stirring conveyance path 10 as a second conveyance path.

As illustrated in FIG. 3, the stirring conveyance path 10 and the collection conveyance path 7 extend from a side surface on the front side of the process cartridge 18, and a supply port 95 is provided on the upper side of the front end of the stirring conveyance path 10. The supply port 95 is a developer receiving port for receiving a premix supplied from a developer supply device outside the developing device 4 into the developer conveyance path, and the premix supplied into the supply port 95 is supplied into the stirring conveyance path 10. The premix contains a toner and a magnetic carrier, and the toner concentration thereof is higher than the toner concentration of the developer in the developing device 4.

In the supply conveyance path 9 as a developer supply unit, a supply screw 8 is disposed as a supply conveyer that conveys the developer to the front side of the plane on which FIG. 4 is drawn while supplying the developer to the developing roller 5. The supply screw 8 is a developer conveying screw that includes a rotation shaft and a blade provided on the rotation shaft, and conveys the developer in the axial direction by rotating. The collection conveyance path 7 is disposed on a downstream side in the surface moving direction from a developing region that is a portion facing the photoconductor 1 of the developing roller 5, and the developed developer having passed through the developing region falls and is collected in the collection conveyance path 7 as a developer collecting section. The collection conveyance path 7 as a developer collecting section includes a collection screw 6 as a first conveyer and a collection conveyer for conveying the collected developer in the same direction as the supply screw 8. The supply conveyance path 9 including the supply screw 8 is disposed laterally to the developing roller 5, and the collection conveyance path 7 including the collection screw 6 is disposed below the developing roller 5.

The stirring conveyance path 10 in which the second conveyer 11 is located is provided below the supply conveyance path 9 in parallel with the collection conveyance path 7. The stirring conveyance path 10 includes a stirring screw 11 that is a stirring conveyer that conveys the developer to the back side of the plane on which FIG. 4 is drawn in the opposite direction to the supply screw 8 while stirring the developer. The supply conveyance path 9 and the stirring conveyance path 10 are partitioned by a first partition wall 133. Openings are provided on both sides of the first partition wall 133 in the axial direction of the developing roller 5 at a position partitioning the supply conveyance path 9 and the stirring conveyance path 10, and the supply conveyance path 9 and the stirring conveyance path 10 communicate with each other. Although the supply conveyance path 9 and the collection conveyance path 7 are also partitioned by the first partition wall 133, an opening is not provided in a portion of the first partition wall 133 that partitions the supply conveyance path 9 and the collection conveyance path 7.

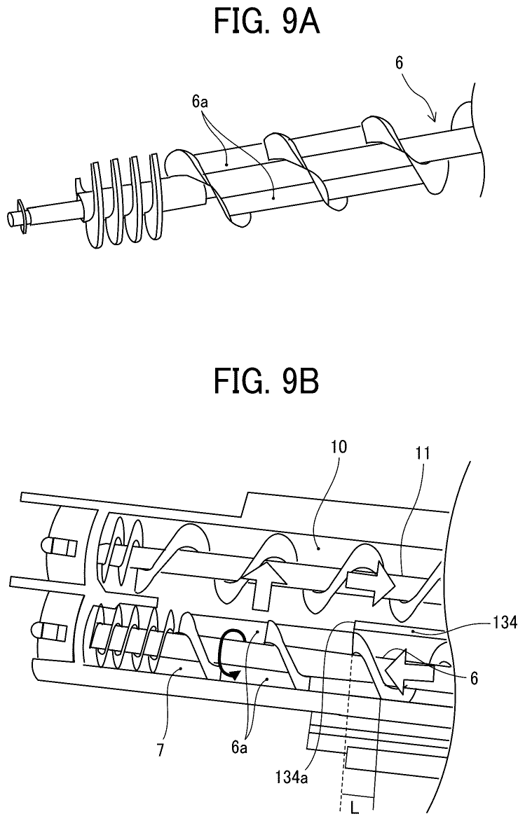

The two conveyance paths of the stirring conveyance path 10 and the collection conveyance path 7 are partitioned by a second partition wall 134. The second partition wall 134 has an opening 134a (see FIG. 9B) on the downstream side of the developer conveyance (the front side of the developing device) by the collection screw 6, and the stirring conveyance path 10 and the collection conveyance path 7 communicate with each other.

The developer after development is collected by the collection conveyance path 7 and conveyed from the back side to the front side of the developing device 4 by the collection screw 6. Then, it is transferred to the stirring conveyance path 10 through the opening 134a as a delivery opening of the second partition wall 134 provided in a portion extending from the side surface on the front side of the process cartridge 18 illustrated in FIG. 3.

The excess developer which is not used for development and is conveyed to the downstream end in the conveyance direction of the supply conveyance path 9 is transferred to the stirring conveyance path 10 through the opening in the vicinity of the front end of the developing device in the first partition wall 133.

In the stirring conveyance path 10, the stirring screw 11 stirs and conveys the collected developer transferred from the collection conveyance path 7, the excess developer transferred from the supply conveyance path 9, and the premix supplied from the supply port 95 as necessary in the direction opposite to the developer conveyed in the collection conveyance path 7 and the supply conveyance path 9 (from the front side to the back side of the developing device). Then, the stirred developer is supplied to an upstream end in the developer conveying direction of the supply conveyance path 9 communicating with a downstream end in the developer conveying direction of the stirring screw 11. Note that a toner concentration sensor is provided below the stirring conveyance path 10, and a toner supply device is operated on the basis of a sensor output of the toner concentration sensor to control the supply of the premix from the toner container to the supply port 95 (see FIG. 3).

Specifically, when the toner concentration sensor falls below a predetermined value with respect to a target sensor output value, the toner supply device is operated to supply the premix from the supply port 95, and when the toner concentration sensor reaches the target sensor output value, the supply is stopped. The target sensor output value is changed on the basis of an image area ratio in a predetermined period or the image density (toner adhesion amount) of the detection toner patch formed between sheets every predetermined number of sheets (for example, every 10 sheets) in continuous printing. Thus, in the present image forming apparatus, the amount of the developer in the developing device changes in the range of 600 to 700 g.

The supply conveyance path 9 has a developer discharge port 94 for discharging a part of the developer in the supply conveyance path 9 to the outside of the developing device 4 when the developer exceeds a predetermined volume. The developing device 4 further includes a discharge conveyance path 2 including a discharge conveying screw 2a that conveys the developer discharged from the developer discharge port 94 to the outside of the developing device 4. The discharge conveyance path 2 is disposed adjacent to the supply conveyance path 9 with a partition wall 135 interposed therebetween on the downstream side of the supply conveyance path 9 in the conveyance direction, and the developer discharge port 94 is an opening provided in the partition wall 135 so as to communicate the supply conveyance path 9 with the discharge conveyance path 2.

The surface of the photoconductor 1 is uniformly charged by the charging unit 71 as a charging device. The surface of the photoconductor 1 subjected to the charging processing is irradiated with the laser light modulated and deflected by the optical writing unit 21. Then, the potential of the irradiated portion (exposed portion) is attenuated. By this attenuation, an electrostatic latent image is formed on the surface of the photoconductor 1. The formed electrostatic latent image is developed by the developing device 4 as a developing unit to become a toner image. The toner image formed on the photoconductor 1 is primarily transferred to an intermediate transfer belt 110 described later. On the surface of the photoconductor 1 after the primary transfer, the transfer residual toner is cleaned by the cleaning blade 72a of the drum cleaning unit 72. The cleaned photoconductor 1 is neutralized by a neutralizer 72c. Then, it is uniformly charged by the charging unit 71, and returns to the initial state.

A series of processes as described above is similar for the process cartridges 18Y, 18M, 18C, and 18K.

Next, the intermediate transfer unit 17 will be described with reference to FIG. 1. The intermediate transfer unit 17 includes an intermediate transfer belt 110, a belt cleaning device 90, and the like. It also includes a stretching roller 14, a drive roller 15, a secondary transfer backup roller 16, and four primary transfer bias rollers 62Y, 62M, 62C, and 62K. The intermediate transfer belt 110 is tensioned and stretched by a plurality of rollers including a stretching roller 14. Then, it is endlessly moved clockwise in FIG. 1 by the rotation of the drive roller 15 driven by a belt drive motor.

The four primary transfer bias rollers 62Y, 62M, 62C, and 62K are arranged so as to be in contact with the inner peripheral surface side of the intermediate transfer belt 110, and receive application of a primary transfer bias from a power supply. The intermediate transfer belt 110 is pressed from the inner peripheral surface side toward the photoconductors 1Y, 1M, 1C, and 1K to form primary transfer nips. In each primary transfer nip, a primary transfer electric field is formed between the photoconductor and the primary transfer bias roller due to the influence of the primary transfer bias. The Y toner image described above formed on the Y photoconductor 1Y is primarily transferred onto the intermediate transfer belt 110 by the influence of the primary transfer electric field and the nip pressure. The M, C, and K toner images formed on the M, C, and K photoconductors 1M, 1C, and 1K are sequentially superimposed and primarily transferred onto the Y toner image.

By the primary transfer of the superimposition, a four-color superimposed toner image (hereinafter, referred to as a four-color toner image) as a multiple toner image is formed on the intermediate transfer belt 110. The four-color toner image superimposed and transferred on the intermediate transfer belt 110 is secondarily transferred to a transfer sheet as a recording body at a secondary transfer nip described later. The transfer residual toner remaining on the surface of the intermediate transfer belt 110 after passing through the secondary transfer nip is cleaned by a belt cleaning device 90 that sandwiches the belt between the drive roller 15 on the left side in the drawing.

Next, the secondary transfer device 22 will be described. The secondary transfer device 22 in which the sheet conveyance belt 24 is stretched by two stretching rollers 23 is disposed below the intermediate transfer unit 17 in FIG. 1. The sheet conveyance belt 24 is endlessly moved counterclockwise in the drawing in accordance with the rotational drive of at least one of the stretching rollers 23. Among the two stretching rollers 23, one roller disposed on the right side in the drawing sandwiches the intermediate transfer belt 110 and the sheet conveyance belt 24 with the secondary transfer backup roller 16 of the intermediate transfer unit 17. By this interposition, a secondary transfer nip is formed in which the intermediate transfer belt 110 of the intermediate transfer unit 17 and the sheet conveyance belt 24 of the secondary transfer device 22 are in contact with each other. Then, a secondary transfer bias having a polarity opposite to that of the toner is applied to the one stretching roller 23 by a power supply. By the application of the secondary transfer bias, a secondary transfer electric field for electrostatically moving the four-color toner image on the intermediate transfer belt 110 of the intermediate transfer unit 17 from the belt side toward the one stretching roller 23 side is formed at the secondary transfer nip. The four-color toner image affected by the secondary transfer electric field and the nip pressure is secondarily transferred to the transfer sheet sent to the secondary transfer nip in synchronization with the four-color toner image on the intermediate transfer belt 110 by the registration roller pair 49 to be described later.

In the sheet feeding device 200 provided in a lower portion of the main body of the image forming apparatus, a plurality of sheet feeding cassettes 44 capable of storing a plurality of transfer sheets in a state of a sheet bundle in an overlapping manner is disposed so as to overlap each other in the vertical direction. Each sheet feeding cassette 44 presses the sheet feeding roller 42 against the uppermost transfer sheet of the sheet bundle. Then, by rotating the sheet feeding roller 42, the uppermost transfer sheet is sent out toward a sheet feeding path 46. The sheet feeding path 46 that receives the transfer sheet fed from the sheet feeding cassette 44 includes a plurality of conveyance roller pairs 47 and a registration roller pair 49 provided in the vicinity of an end in the path. Then, the transfer sheet is conveyed toward the registration roller pair 49.

The transfer sheet conveyed toward the registration roller pair 49 is sandwiched between the rollers of the registration roller pair 49.

On the other hand, in the intermediate transfer unit 17, the four-color toner image formed on the intermediate transfer belt 110 enters the secondary transfer nip along with the endless movement of the intermediate transfer belt 110. The registration roller pair 49 sends out the transfer sheet sandwiched between the rollers at a timing at which the transfer sheet can be brought into close contact with the four-color toner image at the secondary transfer nip. Thus, in the secondary transfer nip, the four-color toner image on the intermediate transfer belt 110 comes into close contact with the transfer sheet. Then, the image is secondarily transferred onto the transfer sheet, and becomes a full color image on a white transfer sheet. The transfer sheet on which the full-color image is formed in this manner exits the secondary transfer nip along with the endless movement of the sheet conveyance belt 24, and then is sent from the sheet conveyance belt 24 to the fixing device 25.

The fixing device 25 includes a belt unit that endlessly moves a fixing belt 26 while being stretched by two rollers, and a pressure roller 27 that is pressed toward one roller of the belt unit. The fixing belt 26 and the pressure roller 27 abut on each other to form a fixing nip, and the transfer sheet received from the sheet conveyance belt 24 is sandwiched therebetween. Among the two rollers in the belt unit, the roller pressed by the pressure roller 27 has a heat source therein, and the heat generated by the heat source pressurizes the fixing belt 26. The pressed fixing belt 26 heats the transfer sheet nipped by the fixing nip. Due to the influence of the heating and the nip pressure, the full-color image is fixed to the transfer sheet. The transfer sheet subjected to the fixing processing in the fixing device 25 is stacked on a stack unit 57 provided outside a left side plate of the printer housing in the drawing, or is returned to the above-described secondary transfer nip to form a toner image on the other surface.

When a document is copied, for example, a bundle of document sheets is placed on a document tray 30 of the automatic document feeder 400. In a case where the bundle of sheet documents is a one-side-bound document closed like a book, the document is placed on a contact glass 32. Prior to this setting, the automatic document feeder 400 is opened with respect to the image forming apparatus, and the contact glass 32 of the scanner 300 is exposed. After the one-side-bound document is placed on the contact glass 32, the one-side-bound document is pressed by the closed automatic document feeder 400.

When the copy start button 38a illustrated in FIG. 2 is pressed after the document is set in this manner, a document reading operation by the scanner 300 is started. However, when a document sheet is set in the automatic document feeder 400, the automatic document feeder 400 automatically moves the document sheet to the contact glass 32 prior to the document reading operation.

In the document reading operation, first, both a first carriage 33 and a second carriage 34 start traveling, and light is emitted from a light source provided in the first carriage 33. Then, reflected light from the document surface is reflected by a mirror provided in the second carriage 34, passes through the imaging forming lens 35, and then enters a reading sensor 36. The reading sensor 36 generates image information according to the incident light. In parallel with such a document reading operation, each device in each of the process cartridges 18Y, 18M, 18C, and 18K, the intermediate transfer unit 17, the secondary transfer device 22, and the fixing device 25 start driving. According to the image information generated by the reading sensor 36, the optical writing unit 21 is driven and controlled to form the Y, M, C, and K toner images on the photoconductors 1Y, 1M, 1C, and 1K, respectively. The yellow, magenta, cyan, and black toner images are transferred onto the intermediate transfer belt 110 and superimposed on the intermediate transfer belt 110 so that a four-color toner image is formed.

Almost simultaneously with the start of the document reading operation, the sheet feeding device 200 starts a sheet feeding operation. In this sheet feeding operation, one of the sheet feeding rollers 42 is selectively rotated, and the transfer sheet is sent out from one of the sheet feeding cassettes 44 accommodated in a paper bank 43 in multiple stages. The fed transfer sheets are separated one by one by a separation roller 45, enter the sheet feeding path 46, and then are conveyed toward the secondary transfer nip by the conveyance roller pair 47. Instead of such sheet feeding from the sheet feeding cassettes 44, sheet feeding from a manual sheet feeding tray 51 may be performed. In this case, after the manual sheet feeding roller 50 is selectively rotated and the transfer sheets on the manual sheet feeding tray 51 are fed, a separation roller 52 separates the transfer sheet one by one and feeds the transfer sheet to a manual sheet feeding path 53 of the printer unit 100.

In the present image forming apparatus, in a case of forming a different-color image including two or more color toners, the intermediate transfer belt 110 is stretched in a posture in which an upper stretched surface thereof is substantially horizontal, and all the photoconductors 1Y, 1M, 1C, and 1K are brought into contact with the upper stretched surface. On the other hand, when a monochrome image including the K toner is formed, the intermediate transfer belt 110 is brought into a posture inclined to the lower left in the drawing, and the upper stretched surface is separated from the photoconductors 1Y, 1M, and 1C for Y, M, and C. Then, among the four photoconductors 1Y, 1M, 1C, and 1K, just the K photoconductor 1K is rotated counterclockwise in the drawing to form just the K toner image. At this time, for Y, M, and C, driving of not just the photoconductor 1 but the developing device is stopped to prevent unnecessary consumption of the photoconductor 1 and the developer.

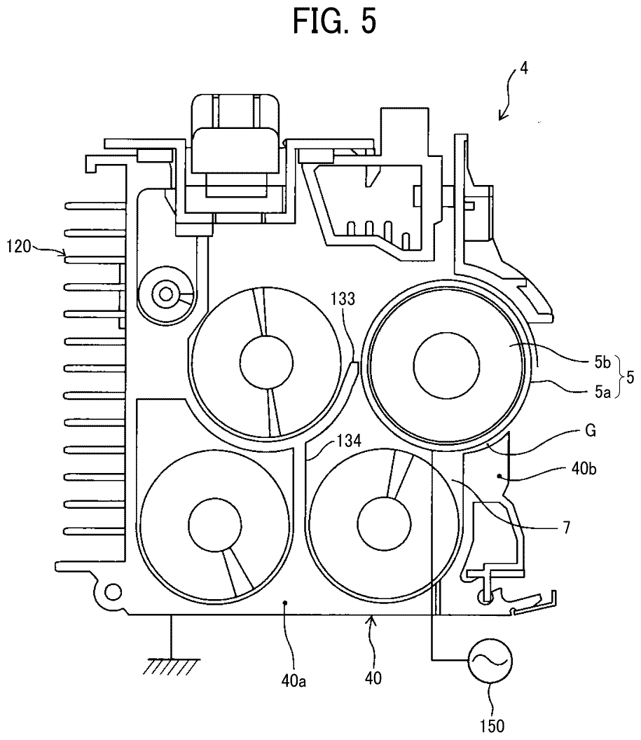

FIG. 5 is a schematic configuration view of the developing device 4.

The development casing 40 as a casing of the developing device 4 includes a developer container 40a that contains the developer, and a gap former 40b that forms a predetermined gap with the surface of the developing roller on the downstream side of the developing region in the rotation direction of the developing roller. The developer container 40a is formed by integrally molding the first partition wall 133, the second partition wall 134, the heat dissipation unit 120, and the like with a metal material such as aluminum. The developer container 40a is electrically grounded. The gap former 40b is made of an insulating resin material, faces the second partition wall 134 to form a wall of the collection conveyance path 7 as a developer collecting section, and forms a casing gap G for allowing the developer of the developing roller 5 to enter the developer container 40a.

In the developing region of the developing device 4, the developer carried on the surface of the developing roller 5 is temporarily conveyed to the outside of the developer container 40a. The developer is carried on the surface of the developing roller 5 by magnetic force and electrostatic force, and after passing through the developing region, the developer is collected again into the developer container 40a. However, since the developing sleeve 5a of the developing roller 5 rotates, it is inevitable that a part of the toner on the surface of the developing roller 5 is released and scattered by the centrifugal force. In order to suppress toner scattering as much as possible, it is effective to generate a suction airflow that is an airflow toward the inside of the developer container 40a in the casing gap G which is an inflow gap. This suction airflow is generated by positioning and bringing the developing roller 5 and the gap former 40b into opposition and close proximity to each other with a predetermined gap within a predetermined range, thereby causing the developer conveyed while rotating together with the developing sleeve 5a to move into the developer container 40a together with air. By generating such a suction airflow, the toner released from the developing roller 5 is also put on the suction airflow toward the inside of the developer container 40a, so that the toner can be collected into the developer container 40a without being scattered to the outside of the developer container 40a.

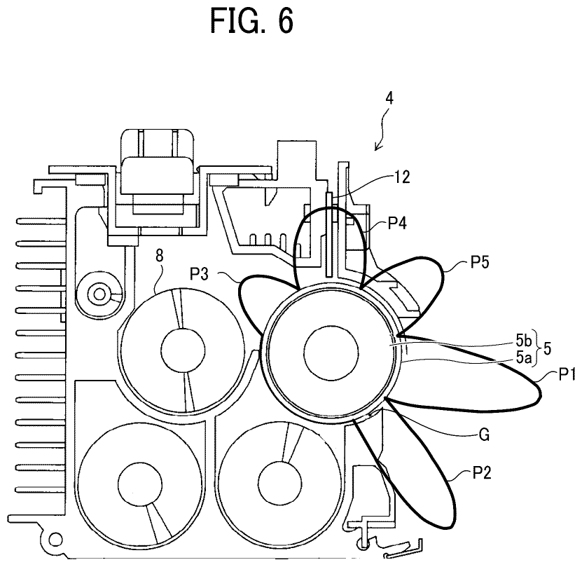

FIG. 6 is a view describing a magnetic flux density by the magnet roller 5b.

As illustrated in FIG. 6, the magnet roller 5b is made of a magnetic material, is in a cylindrical shape, and has a plurality of fixed magnetic poles attached thereto. The plurality of magnetic poles may all be of an integral molding type. The magnet roller 5b is accommodated in the developing sleeve 5a and is fixed without rotating about the axis. The fixed magnetic pole is an elongated rod-shaped magnet, extends along a longitudinal direction of the magnet roller 5b, and is provided over the entire length of the magnet roller 5b.

In the magnet roller 5b, a first magnetic pole P1, a second magnetic pole P2, a third magnetic pole P3, a fourth magnetic pole P4, and a fifth magnetic pole P5 are formed in order along the clockwise direction in FIG. 6. The first magnetic pole P1 is disposed at a position facing the photoconductor 1 and participates in development, and the second magnetic pole P2 is disposed at a position of the casing gap G illustrated in FIG. 5 and is related to the suction airflow. The third magnetic pole P3 is disposed at a position above a position facing the supply screw 8 and is related to the amount of developer supplied to the developing sleeve 5a. The fourth magnetic pole P4 is disposed at a position facing the development doctor 12 and is related to the amount of conveyed developer.

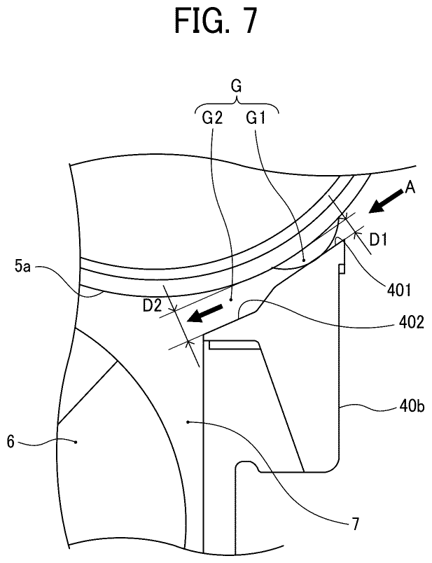

FIG. 7 is a view describing a casing gap G as an inflow gap in the present embodiment.

The casing gap G of the present embodiment includes a first gap G1 that is a first region and a second gap G2 that is a second region. The first gap G1 is located in a region where the developer is spiked due to the second magnetic pole P2 (see FIG. 6). A surface 401 of the gap former 40b facing the surface of the developing roller in the first gap G1 is a curved surface centered on the rotation center of the developing sleeve 5a. A distance D1 (gap) from the surface 401 of the gap former 40b facing the surface of the developing roller in the first gap G1 to the surface of the developing roller 5 is set to a distance at which the developer is spiked by the magnetic force of the second magnetic pole P2 contacts the facing surface 401. In the first gap G1, the spiked developer comes into contact with the facing surface 401, so that the air on the surface of the developing roller can be directed into the developing device by the spiked developer, and the suction airflow indicated by arrow A in the drawing can be generated. In the present embodiment, the distance D1 from the surface 401 facing the surface of the developing roller in the first gap G1 to the surface of the developing roller is set to 0.65 mm.

The second gap G2, which is a second region located on the downstream side in the surface moving direction of the developing sleeve 5a with respect to the first gap G1, is a gap wider than the first gap G1. The second gap G2 is located on a downstream side in the surface moving direction with respect to a downstream end of the region of the developer spike due to the magnetic force of the second magnetic pole P2. Specifically, as illustrated in FIG. 6, the second gap G2 is located in a region where the magnetic force of the magnet roller 5b of the casing gap G is not generated, and the spike of the developer that has entered the second gap G2 is immediately reduced, so that generation of a developing brush is cut.

The surface 402 of the gap former 40b facing the surface of the developing roller in the second gap G2 is an inclined surface in which the distance from the surface of the developing roller increases toward the downstream side in the surface moving direction of the developing roller 5. Thus, the developer dropped from the surface of the developing roller to the facing surface 402 of the gap former 40b in the second gap G2 can be dropped from the facing surface 402 to the collection conveyance path 7 by its own weight, and retention of the developer in the second gap G2 can be suppressed.

By making the second gap G2 wider than the first gap G1, the density of the developer in the second gap G2 can be reduced. Thus, the suction airflow taken in by the spiked developer easily moves into the developing device, and the toner scattering on the surface of the developing roller 5 can be satisfactorily suppressed.

In the present embodiment, the distance D2 from the surface of the developing roller to the surface 402 of the gap former 40b facing the surface of the developing roller in the second gap G2 is equal to or more than 3.50 mm, and the gap of the second gap G2 is wider than the first gap G1 by 5.4 times or more.

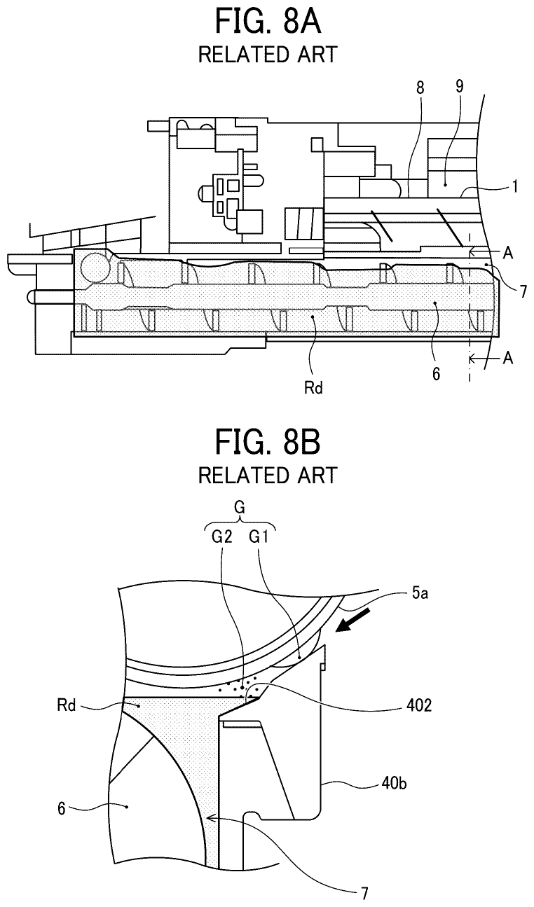

FIGS. 8A and 8B are views describing a related art.

FIG. 8A is a schematic configuration view of the downstream side in the developer conveying direction in the collection conveyance path 7, and FIG. 8B is a cross-sectional view taken along line A-A of FIG. 8A.

As described above, in the present embodiment, the target sensor output value of the toner concentration sensor is changed based on the image area ratio in a predetermined period or the image density (toner adhesion amount) of the detection toner patch formed for each predetermined number of sheets in continuous printing. Therefore, depending on the changed target sensor output value, more premix is replenished from the supply port 95 than in the normal time, and the amount of developer in the developing device becomes larger than in the normal time. As described above, since the amount of the developer in the developing device is large, the developer stays on the downstream side of the collection conveyance path 7 in the developer conveying direction. Then, the developer is collected to the collection conveyance path 7 one after another by continuous printing, so that the amount of the developer retained on the downstream side in the developer conveying direction increases. As a result, as illustrated in FIG. 8A, a portion of the collection conveyance path 7 extending from the side surface on the front side of the process cartridge 18 is filled with the retained developer Rd, and the retained developer Rd extends to a region of the collection conveyance path 7 facing the developing roller 5. Then, as illustrated in FIG. 8B, when the developer surface height of the retained developer Rd reaching the region facing the developing roller 5 becomes higher than the facing surface 402 of the gap former 40b, the retained developer Rd reaches the second gap G2. As a result, the gap of the second gap G2 is narrowed, the generation of the suction airflow is inhibited on the front side of the developing device of the second gap G2, and toner scattering occurred on the front side of the developing device.

FIG. 9A is a schematic perspective view of the collection screw 6 of the present embodiment on the downstream side in the developer conveying direction, and FIG. 9B is an enlarged view of the periphery of a portion where the developer is transferred from the collection conveyance path 7 to the stirring conveyance path 10. In the present embodiment, as illustrated in FIG. 9A, paddles 6a as a delivery facilitator that facilitates delivery of the developer to the stirring conveyance path 10 are provided on the downstream side of the collection screw 6 in the developer conveying direction. Each of the paddles 6a is a plate-like member, and is provided on the collection screw 6 in parallel with the axial direction of the collection screw 6. The paddles 6a are provided at intervals of 180° in the rotation direction of the collection screw 6. The length of the paddles 6a in the axial direction corresponds to the length of two pitches of the blades of the collection screw 6.

As illustrated in FIG. 9B, the paddles 6a are provided in a region facing the opening 134a of the second partition wall 134 that delivers the developer from the collection conveyance path 7 of the collection screw 6 to the stirring conveyance path 10. The two paddles are disposed so as to be shifted from each other by a blade pitch of the collection screw 6 of 0.5 in the axial direction. An upstream end in the developer conveying direction of the collection screw 6 of one of the two paddles 6a is located at the same position as an upstream end in the developer conveying direction of the opening 134a. An upstream end in the developer conveying direction of the other paddle 6a is located on an upstream side of the upstream end in the developer conveying direction of the opening 134a by L mm.

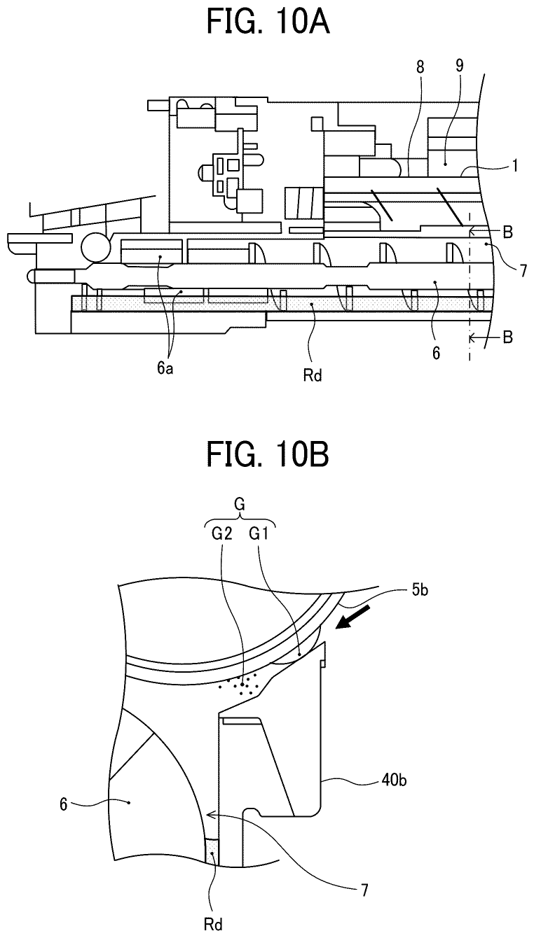

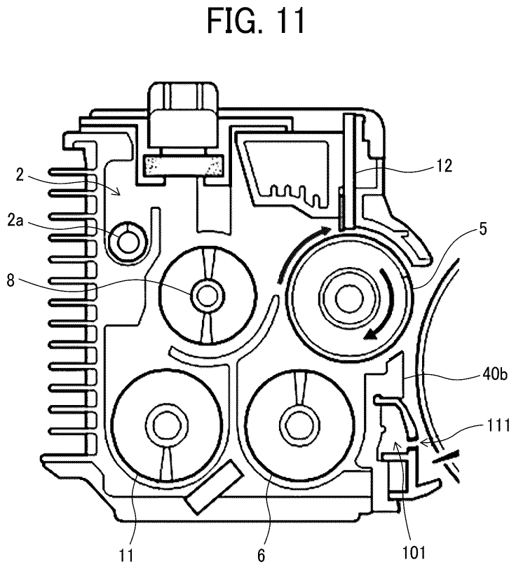

FIG. 10A is a schematic configuration view of the downstream side in the developer conveying direction of the collection conveyance path 7 in the present embodiment, and FIG. 10B is a cross-sectional view taken along line A-A of FIG. 10A.

In the present embodiment, since the paddles 6a are provided in the region facing the opening 134a of the second partition wall 134 of the collection screw 6, the transfer of the developer to the stirring conveyance path 10 is facilitated by the paddles 6a. Thus, as illustrated in FIG. 10A, even under a condition where there is a large amount of developer in the developing device 4, retention of the developer on the downstream side of the collection conveyance path 7 in the developer conveying direction is suppressed. Therefore, as illustrated in FIG. 10B, the gap of the second gap G2 can be prevented from being narrowed by the retained developer Rd on the device front side of the second gap G2 (the downstream side in the developer conveying direction in the collection conveyance path 7). Therefore, the suction airflow is not inhibited on the front side of the apparatus of the second gap G2. This makes it possible to suppress toner scattering on the front side of the image forming apparatus.

Although the above-described configuration suppresses toner scattering, when toner is likely to be scattered due to deterioration of the developer, an influence of a surrounding environment, or the like, there is a case where scattering of toner cannot be completely prevented just by the suction airflow. The toner scattered in this manner adheres to and accumulates on the wall surface of the developing device 4, and when the amount becomes a certain amount, a mass of toner falls from the developing device 4 due to gravity, vibration, or the like, and unintended toner contamination (referred to as a toner fall-off image) may occur.

By periodically performing cleaning by a service person or a user, attached toner on a wall surface or the like of the developing device 4 can be removed, but in some cases, the developing device 4 cannot be easily cleaned. Therefore, a suction duct that sucks the scattered toner may be provided as a device for preventing the accumulation of the scattered toner without cleaning for a longer period of time.

FIG. 11 is a schematic configuration view of the developing device 4 provided with the suction duct 101.

The suction duct 101 is attached to an outer wall surface of the gap former 40b, and a suction port 111 is provided so as to face the surface of the photoconductor 1. The suction duct 101 is connected to a toner dust collector provided in the main body of the image forming apparatus. The toner dust collector includes a filter for collecting toner dust and a fan for generating a dust collection airflow (suction airflow). The suction duct 101 discontinuously arranges the suction port 111 capable of uniformly sucking the scattered toner with respect to the longitudinal direction of the developing roller so as to have a uniform air volume with respect to the longitudinal direction of the developing roller.

The toner scattered without being prevented by the suction airflow falls between the gap former 40b and the photoconductor 1 and is sucked from the suction port 111 of the suction duct 101. The toner sucked by the suction duct 101 is collected by the filter of the toner dust collector. Thus, toner adhesion to the wall surface of the developing device 4 can be further suppressed.

Next, verification experiments performed by the present inventors will be described.

### Verification Experiment 1

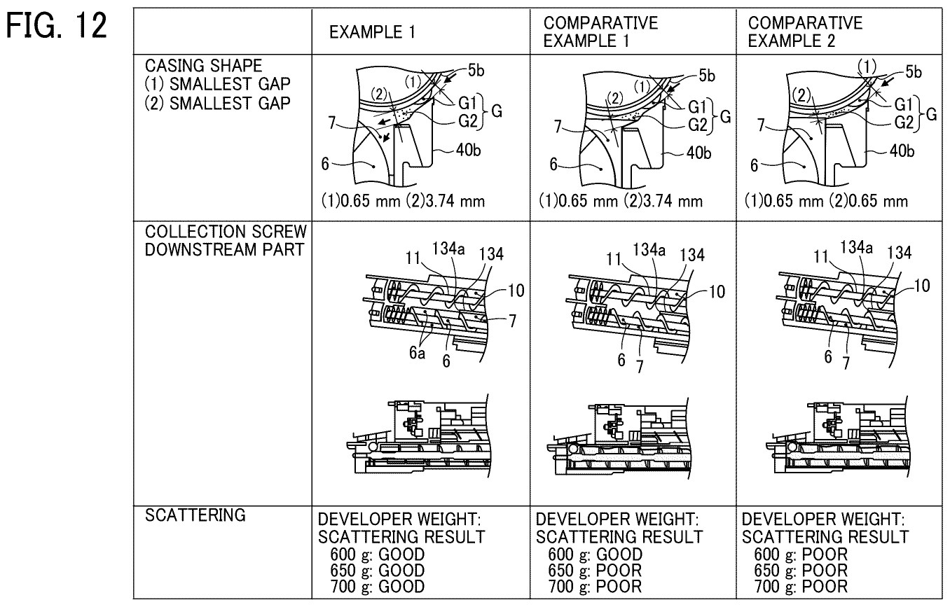

FIG. 12 is a table summarizing configurations of Example 1 and Comparative Examples 1 and 2 and scattering results of the developer.

### Example 1

The gap of the first gap G1 in Example 1 is 0.65 mm, and the gap of the second gap G2 is 3.74 mm. In Example 1, the paddles 6a are provided at an interval of 180° in the region facing the opening 134a of the second partition wall 134 of the collection screw 6.

### Comparative Example 1

Comparative Example 1 has the same configuration as Example 1 except that the paddles 6a are not provided in a region facing the opening 134a of the second partition wall 134 of the collection screw 6.

### Comparative Example 2

Comparative Example 2 has the same configuration as Comparative Example 1 except that the gap of the second gap G2 is 0.65 mm and is the same as the gap of the first gap G1.

The outer wall surface of the development casing 40 was cleaned so that no toner adhered to the outer wall surface was present, the developing devices of Example 1 and Comparative Examples 1 and 2 were set in ProC5300 manufactured by Ricoh Co., Ltd., 10,000 images having an image area ratio of 34% in which toner is likely to scatter were continuously printed for three levels of developer amounts of 600 g, 650 g, and 700 g in the developing device, and a toner scattering speed (toner scattering amount per unit surface moving distance of the developing roller) was obtained. For the toner scattering speed, toner adhering to the outer wall surface of the development casing 40 after continuous printing is sucked, and the weight of the sucked toner is measured. The toner scattering speed is obtained from the measured toner weight and the surface moving distance of the continuously printed developing roller. The surface moving distance of the developing roller can be confirmed by a log recorded in the image forming apparatus.

The calculated toner scattering speed of less than 0.1 mg/km was determined as “Good”. This is because, when the toner scattering speed is equal to or more than 0.1 mg/km, the scattered toner adheres to the outer wall surface or the like of the developing device 4, and the adhering toner drops as a mass, and unintended toner contamination (referred to as a toner fall-off image) may occur.

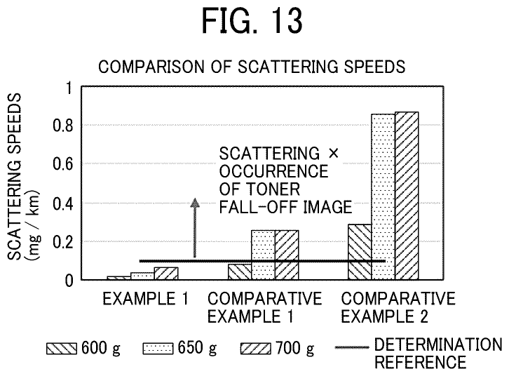

FIG. 13 is a graph illustrating toner scattering speeds with developer amounts of 600 g, 650 g, and 700 g in Example 1 and Comparative Examples 1 and 2.

In Comparative Example 1, when the developer amount of the developing device 4 was 650 g and 700 g, the toner scattering speed was equal to or more than 0.1 mg/km. This is considered to be because in Comparative Example 1, since the paddle 6a is not provided in the collection screw 6, retention of the developer occurred on the downstream side in the developer conveying direction of the collection conveyance path 7. Under the condition that the developer amount of the developing device 4 is equal to or more than 650 g and the developer amount is large, the retained developer reached the region facing the developing roller 5 and the developer surface height of the retained developer that has reached the region facing the developing roller 5 was higher than the facing surface 402 (see FIG. 7) of the second gap G2. As a result, the second gap G2 on the front side of the apparatus was filled with the retained developer, and the suction airflow was obstructed at the second gap G2 on the front side of the image forming apparatus. Thus, it is considered that the toner scattering speed became equal to or more than 0.1 mg/km under the condition that the developer amount in the developing device 4 is equal to or more than 650 g and the developer amount is large.

In Comparative Example 2, the gap of the second gap G2 of the casing gap G is set to 0.65 mm, which is the same as the gap of the first gap G1. Therefore, it is considered that the suction airflow taken in by the spiked developer hardly moves into the developing device, the suction airflow is not sufficiently generated, and the toner scattering speed is equal to or more than 0.1 mg/km even when the developer amount of the developing device 4 is 600 g.

On the other hand, in Example 1, the toner scattering speed could be suppressed to less than 0.1 mg/km under any of the conditions of 600 g, 650 g, and 700 g. In Example 1, the gap of the second gap G2 is wider than the gap of the first gap G1 by 5.4 times or more. As a result, the taken-in suction airflow could be satisfactorily moved into the developing device, and the suction airflow could be satisfactorily generated. The developer in the collection conveyance path 7 could be satisfactorily transferred to the stirring conveyance path 10 by the paddle 6a, and the retention of the developer on the downstream side of the developer conveyance in the collection conveyance path 7 could be suppressed. As a result, even under the condition that the developer amount in the developing device 4 is equal to or more than 650 g and the developer amount is large, the gap of the second gap G2 on the front side of the image forming apparatus (downstream side in the developer conveying direction of the collection conveyance path 7) is not narrowed by the retained developer. Therefore, it is considered that the suction airflow can be satisfactorily generated under any condition of 600 g, 650 g, and 700 g, and the toner scattering speed can be suppressed to less than 0.1 mg/km.

### Verification Experiment 2

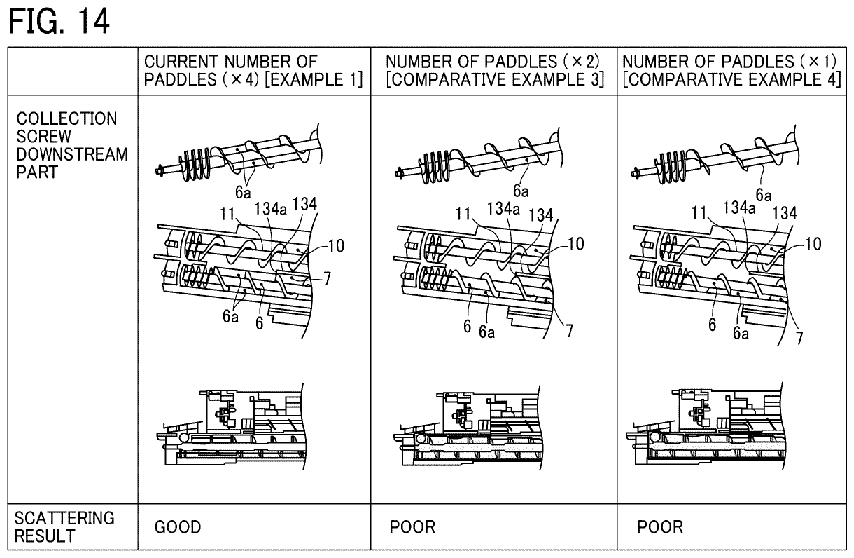

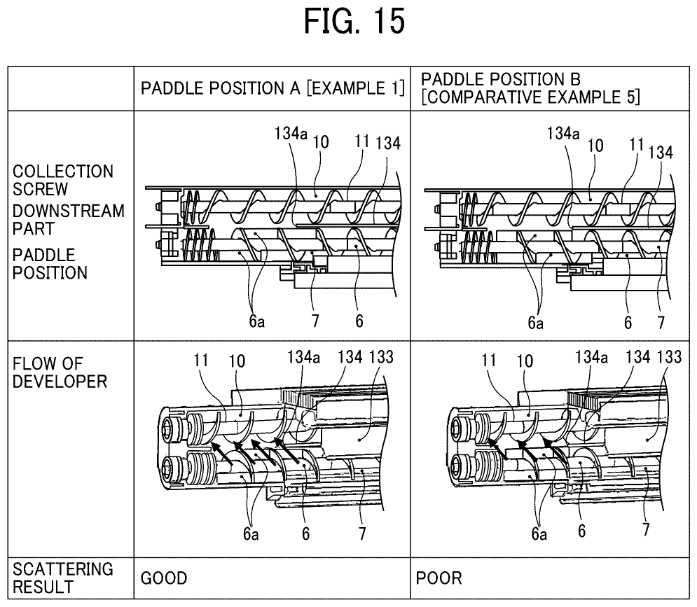

Verification Experiment 2 verified the relationship between the paddles 6a provided in the collection screw 6 and the toner scattering speed. FIG. 14 is a table summarizing Verification Experiment 2 of Example 1 and Comparative Examples 3 and 4. FIG. 15 is a table summarizing Verification Experiment 2 of Example 1 and Comparative Example 5.

### Comparative Example 3

Comparative Example 3 is similar to Example 1 except that the paddle 6a is provided at one position in the rotation direction of the collection screw 6.

### Comparative Example 4

Comparative Example 4 is similar to Comparative Example 3 except that the length of the collection screw 6 of the paddle 6a in the developer conveying direction is set to the length of one pitch of the blades of the collection screw 6.

### Comparative Example 5

Comparative Example 5 is similar to Example 1 except that the upstream end in the developer conveying direction of the collection screw 6 of each of the two paddles 6a provided at an interval of 180° in the rotation direction of the collection screw 6 is provided at the same position as the upstream end in the developer conveying direction of the collection screw 6 of the opening 134a.

The developing devices of Comparative Examples 3, 4, and 5 were set in ProC5300 manufactured by Ricoh Co., Ltd., the developer amount in the developing device was set to 700 g, 10,000 sheets of images having an image area ratio of 34% were printed, and the toner scattering speed (toner scattering amount per unit surface moving distance of the developing roller) was measured.

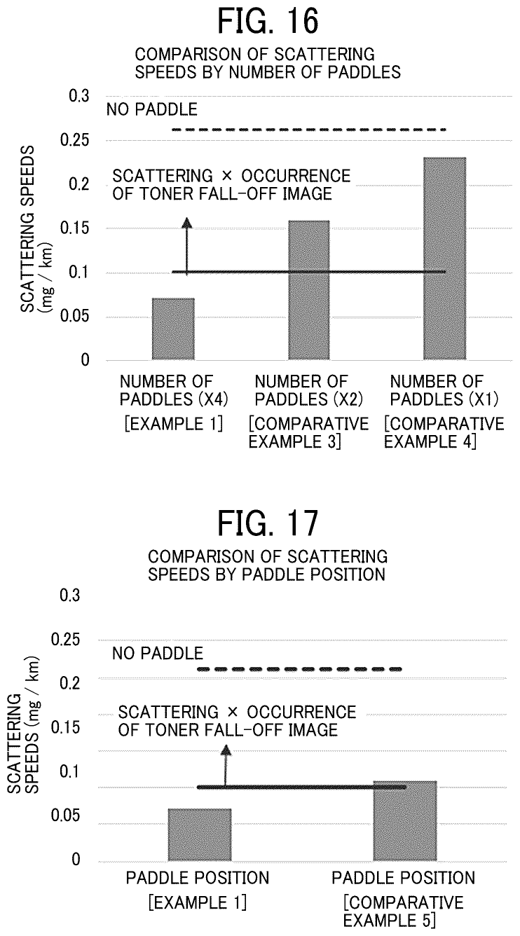

FIG. 16 is a graph illustrating toner scattering speeds with the developer amount of 700 g in Example 1 and Comparative Examples 3 and 4.

As illustrated in FIG. 16, in Comparative Example 3 and Comparative Example 4, it is considered that the effect of facilitating the transfer of the developer to the stirring conveyance path 10 by the paddle 6a was insufficient, and the retention of the developer on the downstream side in the developer conveying direction of the collection conveyance path 7 could not be sufficiently suppressed. As a result, it is considered that, with the developer amount of 700 g in the developing device, the gap of the second gap G2 on the front side of the image forming apparatus (downstream side in the developer conveying direction of the collection conveyance path 7) was narrowed by the retained developer, and the toner scattering speed became equal to or more than 0.1 mg/km.

FIG. 17 is a graph illustrating toner scattering speeds with the developer amount of 700 g in Example 1 and Comparative Example 5.

As illustrated in FIG. 17, in Comparative Example 5, the toner scattering speed slightly exceeded 0.1 mg/km. In Example 1, the upstream end of one of the two paddles 6a in the developer conveying direction of the collection screw 6 is located on the upstream side of the upstream end in the developer conveying direction of the collection screw 6 of the opening 134a. With this paddle, the developer in the collection conveyance path 7 on the upstream side of the upstream end of the opening 134a is also fed toward the stirring conveyance path 10. The developer fed to the stirring conveyance path 10 by the paddle 6a moves to the downstream side in the conveying direction of the developer along the blades of the collection screw 6 as indicated by arrows in FIG. 15. Therefore, the developer in the collection conveyance path 7 on the upstream side of the upstream end of the opening 134a fed by the paddle 6a is transferred to the stirring conveyance path 10 through the opening 134a without being blocked by the second partition wall 134. As described above, in Example 1, since the developer in the collection conveyance path 7 on the upstream side of the upstream end of the opening 134a can also be transferred to the stirring conveyance path 10, the retention of the developer on the upstream side of the opening 134a in the collection conveyance path 7 can be satisfactorily suppressed as compared with Comparative Example 5. Thus, in Example 1, it is considered that the toner scattering speed could be suppressed to less than 0.1 mg/km even under the condition that the developer amount in the developing device is as large as 700 g.

As described above, from the results of Verification Experiment 2, the two paddles 6a are provided at least at an interval of 180° in the rotation direction of the collection screw 6, and the axial length of the paddle 6a is set to 2 pitches or more of the blades of the collection screw 6. The upstream end of at least one of the two paddles 6a in the developer conveying direction of the collection screw 6 is located on an upstream side of the upstream end of the opening 134a in the developer conveying direction. With such a configuration, it was found that even when the amount of the developer in the developing device is 700 g, it is possible to satisfactorily suppress the retention of the developer on the downstream side in the developer conveying direction of the collection conveyance path 7 and to satisfactorily suppress toner scattering.

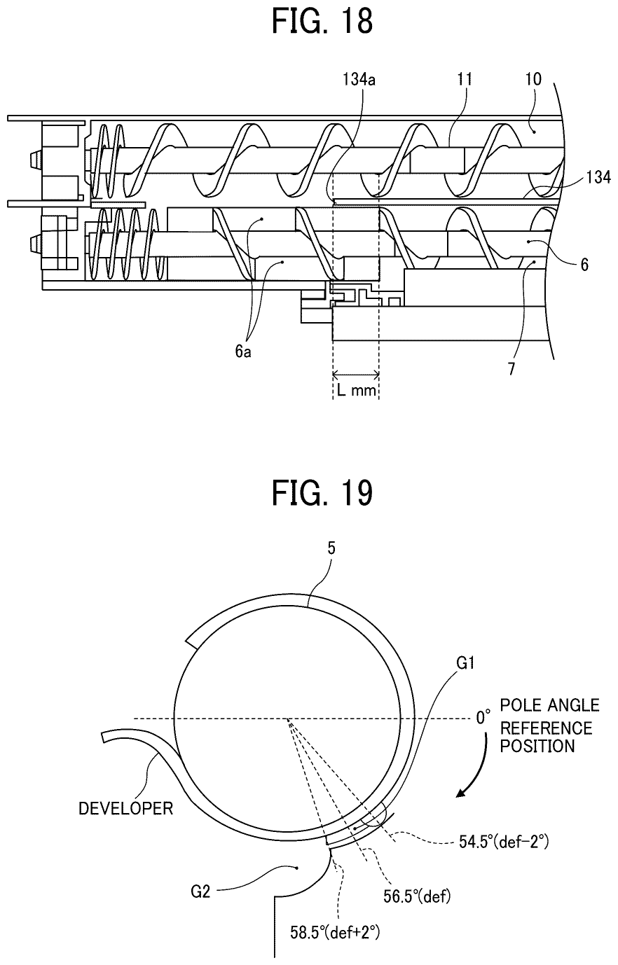

In Example 1, the axial length of the two paddles 6a is set to the length of two pitches of the blades of the collection screw 6, and the other paddle is disposed to be shifted in the axial direction by 0.5 pitches of the blades of the collection screw 6 with respect to one paddle. However, it is not limited thereto, and a configuration as illustrated in FIG. 18 may be employed. Specifically, the axial lengths of the two paddles 6a are 2.5 pitch lengths of the blades of the collection screw 6, and the positions of the upstream end and the downstream end in the developer conveying direction of the two paddles 6a are the same. Then, the positions of the upstream ends of the two paddles 6a in the developer conveying direction are located on an upstream side of the upstream end in the developer conveying direction of the opening 134a. With such a configuration, it is possible to increase the amount of the developer transferred from the collection conveyance path 7 to the stirring conveyance path 10 per unit time as compared with the paddle configuration of Example 1. Thus, the retention of the developer on the downstream side in the developer conveying direction of the collection conveyance path 7 can be further suppressed as compared with Example 1.

In Example 1, two paddles are provided at an interval of 180° in the rotation direction of the collection screw 6, but three or more paddles may be provided at a predetermined interval in the rotation direction of the collection screw 6.

### Verification Experiment 3

Verification Experiment 3 confirmed the relationship between the arrangement of the second magnetic pole P2 and the toner scattering speed.

In Verification Experiment 3, the toner scattering speed was examined in the same manner as in Verification Experiment 2 for the case where the second magnetic pole P2 was disposed on the upstream side of the first gap G1 in the surface moving direction of the developing roller 5, the case where the second magnetic pole P2 was disposed at the center of the first gap G1 in the surface moving direction of the developing roller 5, and the case where the second magnetic pole P2 was disposed on the downstream side of the first gap G1 in the surface moving direction of the developing roller 5. Except for the arrangement position of the second magnetic pole P2, the configuration is similar to that of Example 1.

As illustrated in FIG. 19, the pole angle of the second magnetic pole P2 in the case where the second magnetic pole P2 was disposed at the center of the first gap G1 in the surface moving direction of the developing roller 5 is 56.5°. The pole angle of the second magnetic pole P2 in the arrangement on the upstream side of the first gap G1 in the surface moving direction of the developing roller 5 is 54.5°, and the pole angle of the second magnetic pole P2 in the arrangement on the downstream side of the first gap G1 in the surface moving direction of the developing roller 5 is 58.5°. The polar angle is an angle with respect to a polar angle reference line, which is a line connecting the rotation center of the developing roller 5 and the rotation center of the photoconductor 1.

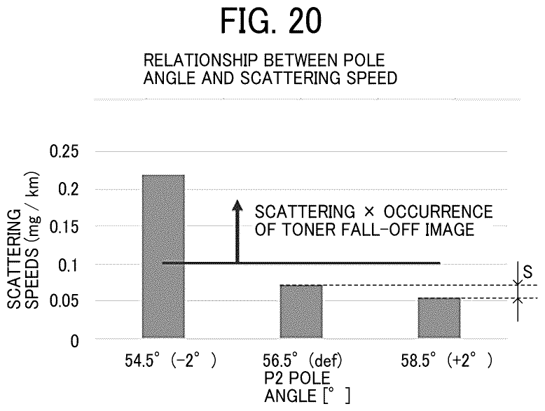

As illustrated in FIG. 20, in the case where the second magnetic pole P2 was disposed on the upstream side of the first gap G1 in the surface moving direction of the developing roller 5, the toner scattering speed became equal to or more than 0.1 mg/km, and the toner scattering could not be suppressed. On the other hand, in the case where the second magnetic pole P2 was disposed at the center of the first gap G1 in the surface moving direction of the developing roller 5 and the case where the second magnetic pole P2 was disposed on the downstream side of the first gap G1 in the surface moving direction of the developing roller 5, the toner scattering speed could be suppressed to less than 0.1 mg/km. In the case where the first gap G1 was disposed on the downstream side in the surface moving direction of the developing roller 5, the toner scattering could be further suppressed as compared with the case where the first gap G1 was disposed at the center.

From this, it was found that, by disposing the second magnetic pole P2 between the center and the downstream side of the first gap G1 in the surface moving direction of the developing roller 5, the suction airflow can be favorably generated, and the toner scattering can be favorably suppressed.

Preferred embodiments of the present disclosure have been described above, but the present disclosure is not limited to such particular embodiments. Unless otherwise particularly limited in the above description, various modifications and alterations may be made without departing from the scope of the gist of the present disclosure in the claims.

The above-described embodiment and modifications are limited examples, and the present disclosure includes, for example, the following aspects having advantageous effects.

### Aspect 1

According to Aspect 1, a developing device includes: a developer carrier such as the developing roller 5 that carries a developer including a magnetic carrier and a toner on a surface and develops a latent image on a latent image bearer such as the photoconductor 1; and a casing such as the development casing 40 that forms an internal space that accommodates the developer inside and is provided with an opening that causes a part of a surface of the developer carrier in a rotation direction of the developer carrier to face the latent image bearer, the casing including a first conveyance path such as the collection conveyance path 7 including a first conveyer such as the collection screw 6 that conveys the developer collected from the developer carrier in an axial direction of the developer carrier, and a second conveyance path such as the stirring conveyance path 10 disposed in parallel with the first conveyance path and including a second conveyer such as the stirring screw 11 that receives the developer conveyed to a most downstream side of the first conveyance path in a conveyance direction, and conveys the received developer in a direction opposite to a developer conveying direction of the first conveyer, the developing device having a structure that allows outside air to flow into the internal space of the casing along with rotation of the developer carrier through an inflow gap such as the casing gap G formed between an edge of the opening located on a downstream side in the rotation direction of the developer carrier and the surface of the developer carrier, the inflow gap including a first region such as the first gap G1 located in a region where the developer carried on the developer carrier is spiked by a magnetic pole such as the second magnetic pole P2 of the developer carrier, and a second region such as the second gap G2 located on a downstream side of the first region in the rotation direction of the developer carrier and having a larger gap between the casing and the surface of the developer carrier than the first region, and a delivery facilitator such as the paddle 6a that facilitates delivery of the developer to the second conveyance path being provided on a downstream side of the first conveyer in the conveyance direction.

Thus, since the delivery of the developer to the second conveyance path is facilitated by the delivery facilitator, it is possible to suppress retention of the developer on the downstream side of the first conveyance path in the developer conveying direction can be suppressed. Thus, the gap on the downstream side in the developer conveying direction in the second region can be prevented from being filled with the developer, and the inflow of outside air toward the internal space of the casing can be prevented from being blocked on the downstream side in the developer conveying direction in the second region. Thus, scattering of the developer can be favorably suppressed.

### Aspect 2

According to Aspect 2, in the developing device of Aspect 1, a gap of the second region such as the second gap G2 is 5.4 times or more a gap of the first region such as the first gap G1.

Thus, as described in the embodiment, the suction airflow can be caused to favorably flow into the developing device.

### Aspect 3

According to Aspect 3, in the developing device of Aspect 1 or Aspect 2, the delivery facilitator such as the paddle 6a is a plate parallel to the axial direction, and is provided at an interval of 180° in a rotation direction of the first conveyer such as the collection screw 6.

Thus, as described in the embodiment, the retention of the developer on the downstream side in the developer conveying direction of the first conveyance path such as the collection conveyance path 7 can be satisfactorily suppressed. Thus, even under a condition where the developer amount in the developing device is large, the gap on the downstream side in the conveyance direction of the first conveyer in the second region can be prevented from being filled with the developer, and the inflow of the outside air toward the internal space of the casing can be prevented from being blocked on the downstream side in the conveyance direction of the first conveyer in the gap in the second region. Thus, toner scattering can be favorably suppressed.

### Aspect 4

According to Aspect 4, in the developing device of any one of Aspect 1 to Aspect 3, the casing such as the development casing 40 further includes: a partition such as the second partition wall 134 that partitions the first conveyance path such as the collection conveyance path 7 and the second conveyance path such as the stirring conveyance path 10; and a delivery opening such as the opening 134a to deliver the developer from the first conveyance path to the second conveyance path, and the delivery facilitator such as the paddle 6a is a plate parallel to the axial direction, the first conveyer such as the collection screw 6 is a conveying screw, and an upstream end of the delivery facilitator is located on an upstream side of an upstream end of the delivery opening in the developer conveying direction of the first conveyer.

Thus, as described in the embodiment, the developer transferred by the delivery facilitator located on the upstream side of the upstream end in the conveyance direction of the delivery opening is guided by the blades of the first conveyer such as the collection screw 6, moves to the downstream side in the developer conveying direction, and is transferred to the second conveyance path such as the stirring conveyance path 10 through the delivery opening without being blocked by the partition such as the second partition wall 134. As described above, the developer on the upstream side in the developer conveying direction of the delivery opening of the first conveyance path can also be transferred to the second conveyance path, and the retention of the developer on the downstream side in the developer conveying direction of the first conveyance path can be favorably suppressed. Thus, even under a condition where the developer amount in the developing device is large, the gap on the downstream side in the conveyance direction of the first conveyer in the second region can be further prevented from being filled with the developer, and the inflow of the outside air toward the internal space of the casing can be prevented from being blocked on the downstream side in the conveyance direction of the first conveyer in the gap in the second region. Thus, toner scattering can be favorably suppressed.

### Aspect 5

According to Aspect 5, in the developing device of any one of Aspect 1 to Aspect 4, the magnetic pole of the developer carrier such as the second magnetic pole P2 that causes the developer to spike in the first region such as the first gap G1 is located between a center and a downstream end of the first region in the rotation direction of the developer carrier.

Thus, as described in Verification Experiment 3, as compared with the case where the magnetic pole of the developer carrier such as the second magnetic pole P2 is located on the upstream side of the center of the first region, the suction airflow can be generated satisfactorily, and the toner scattering can be suppressed.

### Aspect 6

According to Aspect 6, in the developing device of Aspect 5, when viewed from the axial direction of the developer carrier such as the developing roller 5, an angle of a line connecting a rotation center of the developer carrier and the magnetic pole of the developer carrier such as the second magnetic pole P2 that causes the developer to spike in the first region such as the first gap G1 with respect to a line connecting the rotation center of the developer carrier and a rotation center of the latent image bearer such as the photoconductor 1 is equal to or more than 56.5° and equal to or less than 58.5°.

Thus, as described in Verification Experiment 3, as compared with the case where the magnetic pole of the developer carrier such as the second magnetic pole P2 is located on the upstream side of the center of the first region, the suction airflow can be generated satisfactorily, and the toner scattering can be suppressed.

### Aspect 7

According to Aspect 7, an image forming apparatus includes a latent image bearer such as the photoconductor 1 that bears a latent image and a developing device 4 that develops a latent image on the latent image bearer, the developing device of any one of Aspect 1 to Aspect 6 being used as the developing device.

Thus, contamination of the inside of the image forming apparatus due to scattering of the toner from the developing device and contamination of the image due to the scattered toner can be suppressed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A developing device comprising:
a developer carrier that carries a developer including a magnetic carrier and a toner on a surface thereof and develops a latent image on a latent image bearer;
a casing including:
a developer container that accommodates the developer inside;
a gap former that forms an inflow gap with the surface of the developer carrier therebetween, at a downstream side of a developing region where the developer carrier faces the latent image bearer in a rotation direction of the developer carrier, to allow outside air to flow into the casing through the inflow gap along with rotation of the developer carrier;
a first conveyance path including a first conveyer that conveys the developer collected from the developer carrier in an axial direction of the developer carrier; and
a second conveyance path disposed in parallel with the first conveyance path and including a second conveyer that receives the developer conveyed to a most downstream side in a conveyance direction of the first conveyance path, and conveys the received developer in a direction opposite to a developer conveying direction of the first conveyer,
wherein the inflow gap includes a first region located in a region where the developer carried on the developer carrier is spiked by a magnetic pole of the developer carrier, and a second region located on a downstream side of the first region in the rotation direction of the developer carrier and in which a gap between the gap former and the surface of the developer carrier is larger than that in the first region, and
wherein the first conveyer includes, on a downstream side in the conveyance direction, a delivery facilitator that facilitates delivery of the developer to the second conveyance path.

2. The developing device according to claim 1,
wherein a gap of the second region is 5.4 times or more a gap of the first region.

3. The developing device according to claim 1,
wherein the delivery facilitator is a plate parallel to the axial direction, and is provided at an interval of 180° in a rotation direction of the first conveyer.

4. The developing device according to claim 1,
wherein the casing further includes:
a partition that partitions the first conveyance path and the second conveyance path; and
a delivery opening to deliver the developer from the first conveyance path to the second conveyance path, and
wherein the delivery facilitator is a plate parallel to the axial direction,
the first conveyer is a conveying screw, and
an upstream end of the delivery facilitator is located on an upstream side of an upstream end of the delivery opening in the developer conveying direction of the first conveyer.

5. The developing device according to claim 1,
wherein the magnetic pole of the developer carrier that causes the developer to spike in the first region is located between a center and a downstream end of the first region in the rotation direction of the developer carrier.

6. The developing device according to claim 5,
wherein when viewed from the axial direction of the developer carrier, an angle of a line connecting a rotation center of the developer carrier and the magnetic pole of the developer carrier that causes the developer to spike in the first region with respect to a line connecting the rotation center of the developer carrier and a rotation center of the latent image bearer is equal to or more than 56.5° and equal to or less than 58.5°.

7. An image forming apparatus comprising:
a latent image bearer that bears a latent image; and
a developing device according to claim 1 that develops the latent image on the latent image bearer.
